(19) United States
(12) Patent Application Publication
(10) Pub. No.: US 2006/0291675 A1
(43) Pub. Date: Dec. 28, 2006

(54) Fragrance emitting and stopping device for a cell phone

(76) Inventors: Kuang-Te Liu, Caotun Township (TW); Chin-Hungun Chang, Taichung City (TW)

Correspondence Address: CHARLES E. BAXLEY, ESQ., 90 JOHN STREET, THIRD FLOOR, NEW YORK, NY, 10038, US

(21) Appl. No.: 11/169,610

(22) Filed: Jun. 28, 2005

(51) Int. Cl. H04R 25/00

(52) U.S. Cl. 381/177

(57) ABSTRACT

The present invention relates to a fragrance emitting and stopping device used on a cell phone, wherein an activator can produce an electromagnetic force after being activated, and the slide device can be moved to a position at which the through hole on the slide device is aligned with or offset from the mouth of the fragrance bottle. Therefore, the fragrance can be released from or blocked in the fragrance bottle inside the cell phone.

### BACKGROUND OF THE INVENTION

1. Field of the Invention

The present invention relates to a fragrance emitting device, and more particularly to a fragrance emitting and stopping device used on a cell phone.

2. Description of the Prior Arts

Cell phone is one of the indispensable consumer electronic products, thanks to the fast development of the communication technology, cell phone is becoming smaller and cheaper, and more and more people have had or will have a cell phone, imperceptibly, so the world is becoming smaller.

Cell phone has been wildly used in people's daily life but merely as a communication device. Since innovative is inexorable trend of the modern industrial world, particularly for the electronic field, in recently years, a lot of novel cell phones with multiple functions have been developed, including personal management function color screen, digital camera, multimedia, game, polyphony, and even some cell phones have e-mail receiving/sending function. However, most of the existing functions are the improvements of communication technology. Therefore, the present invention has developed a new style cell phone that is provided with a fragrance emitting and stopping device.

### SUMMARY OF THE INVENTION

The primary objective of the present invention is to provide a fragrance emitting and stopping device used on a cell phone. An activator can produce an electromagnetic force after being activated, and the slide device can be moved to a position at which the through hole on the slide device is aligned with or offset from the mouth of the fragrance bottle. Therefore, the fragrance can be released from or blocked in the fragrance bottle inside the cell phone.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a cell phone provided with a fragrance emitting and stopping device in accordance with a first embodiment of the present invention;

FIG. 2 is an illustrative view for showing that the fragrance emitting and stopping device is turned on;

FIG. 3 is an illustrative view for showing that the fragrance emitting and stopping device is turned off;

FIG. 4 is flow chart for illustrating the work principle of the fragrance emitting and stopping device in accordance with the present invention;

FIG. 5 is an illustrative view in accordance with a second embodiment of the present invention, for showing the turn-off state of the fragrance emitting and stopping device;

FIG. 6 is an illustrative view in accordance with the second embodiment of the present invention, for showing the turn-on state of the fragrance emitting and stopping device;

FIG. 7 is an illustrative view in accordance with the second embodiment of the present invention, for showing another turn-on state of the fragrance emitting and stopping device;

FIG. 8 is an illustrative view in accordance with a third embodiment of the present invention, for showing the turn-off state of the fragrance emitting and stopping device;

FIG. 9 is an illustrative view in accordance with the third embodiment of the present invention, for showing a turn-on state of the fragrance emitting and stopping device;

FIG. 10 is an illustrative view in accordance with the third embodiment of the present invention, for showing another turn-on state of the fragrance emitting and stopping device.

### DETAILED DESCRIPTION OF THE PREFERRED EMBODIMENTS

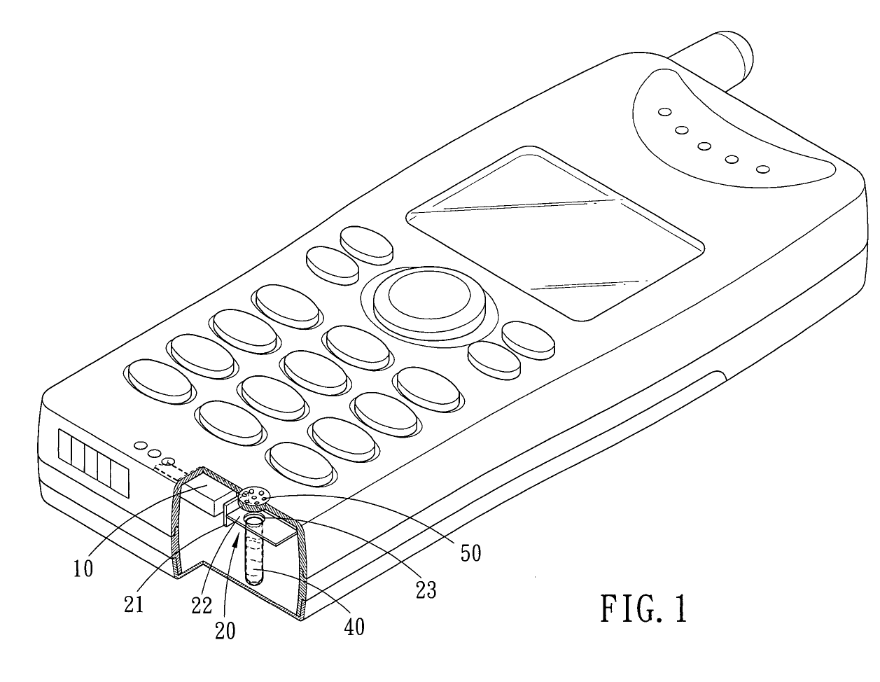

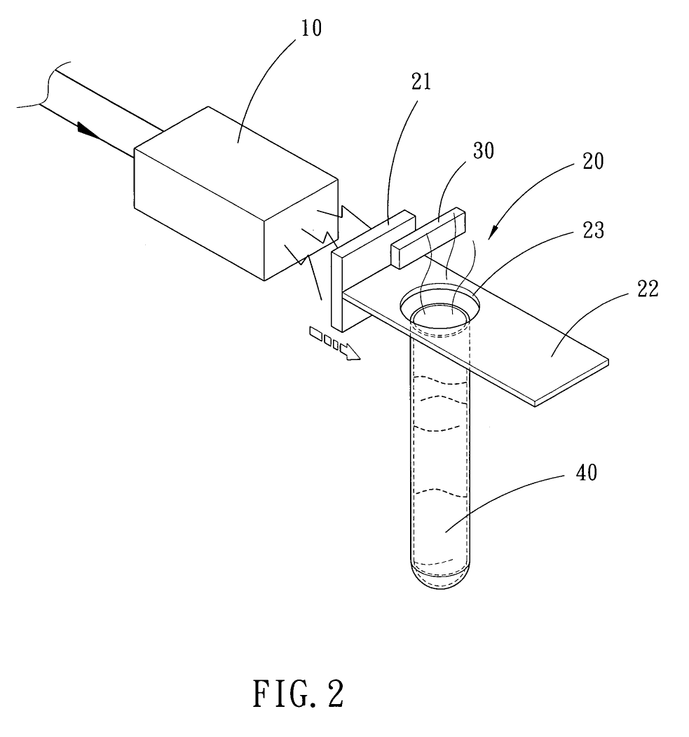

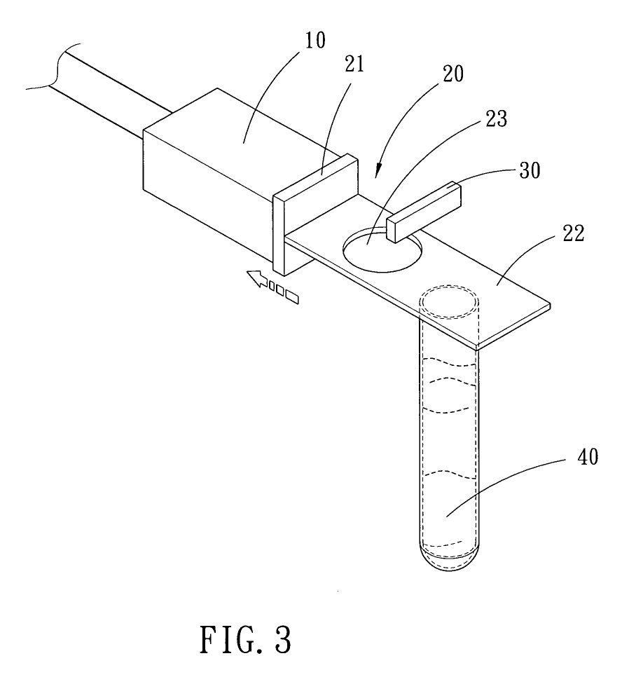

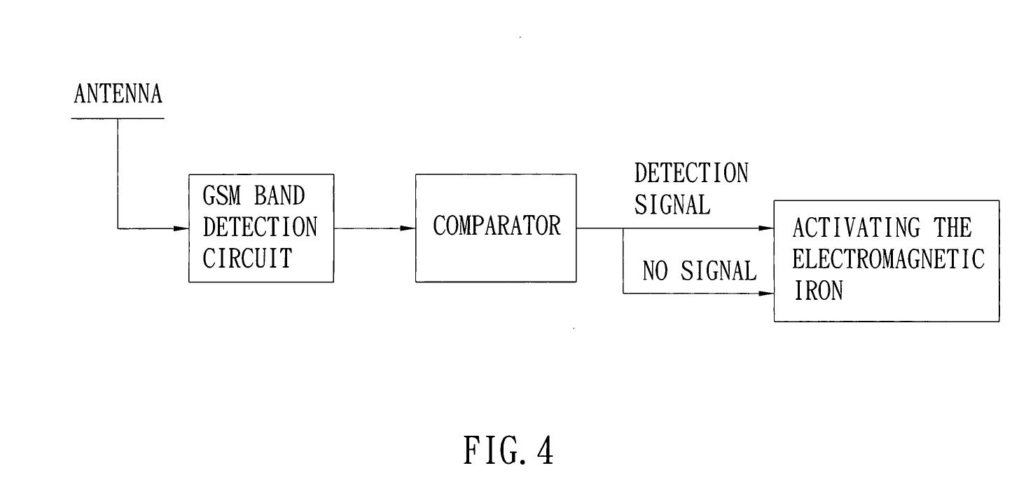

Referring to FIGS. 1-4, a fragrance emitting and stopping device for a cell phone in accordance with a first embodiment of the present invention is shown and comprises: an activator 10, a slide device 20, a positioning member 30 and fragrance bottle 40 arranged in the housing of a cell phone, and a fragrance-releasing hole 50 formed on the cell phone.

The activator 10 is an electromagnetic iron (a soft iron wound with wires and serves to convert electric power into magnetic force), when a call comes in, the activator 10 will be turned on and generate an electromagnetic field, and if there is no coming call, no electromagnetic field will be generated.

The slide device 20 comprises a permanent magnetic iron 21 disposed on the slide base 22, and the permanent magnetic iron 21 is located toward the activator 10. On the slide base 22 is formed a through hole 23 that will be caused to move when the slide base 22 is moved by the electromagnetic effect (attraction or repulsion) between the permanent magnetic iron 21 of the slide device 20 and the activator 10.

The positioning member 30 is located toward the activator 10 and arranged on the same side of the slide base 22 of the slide device 20. When an electromagnetic action is produced between the permanent magnetic iron 21 of the slide device 20 and the activator 10, and the slide device 20 is caused to move, at this moment, the positioning member 30 will act as a limiter to stop further movement of the slide device 20.

The fragrance bottle 40 serves to contain solid fragrance substance and is located at a side of the through hole 23 on the slide base 22 of the slide device 20, the fragrance releasing hole 50 is located at another side of the through hole 23, and the through hole 23 can be moved to a position aligned to the mouth of the fragrance bottle 40.

When a call comes in, the cell phone will produce a detection signal and send current to the activator 10, and the activator 10 will produce an electromagnetic force. Since the permanent magnetic iron 21 of the slide device 20 is located opposite the activator 10, the magnetic force generated by the activator 10 will repel the magnetic force of the magnetic iron 21, and as a result, the slide device 20 will be caused to move. At this moment, the positioning member 30 will stop the slide device 20 at a position at which the through hole 23 on the slide device is aligned with the mouth of the fragrance bottle 40. Therefore, the fragrance can be released from fragrance bottle 40 through the through hole 23 and the fragrance-releasing hole 50.

When there is no coming call, the cell phone doesn't produce detection signal, and the activator 10 will not produce any electromagnetic force. Since the permanent magnetic iron 21 of the slide device 20 is located opposite the activator 10, they will be attracted to each other. Consequently the through hole 23 of the slide base 22 of the slide device 20 will move back to its original position that is offset from the fragrance bottle 40, and at this position, the cell phone stops releasing fragrance from the fragrance bottle 40.

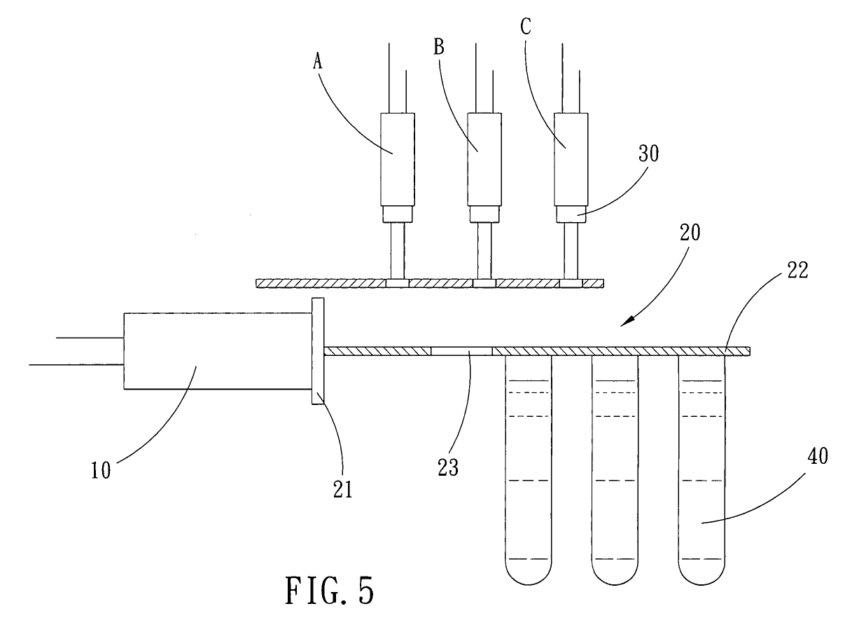

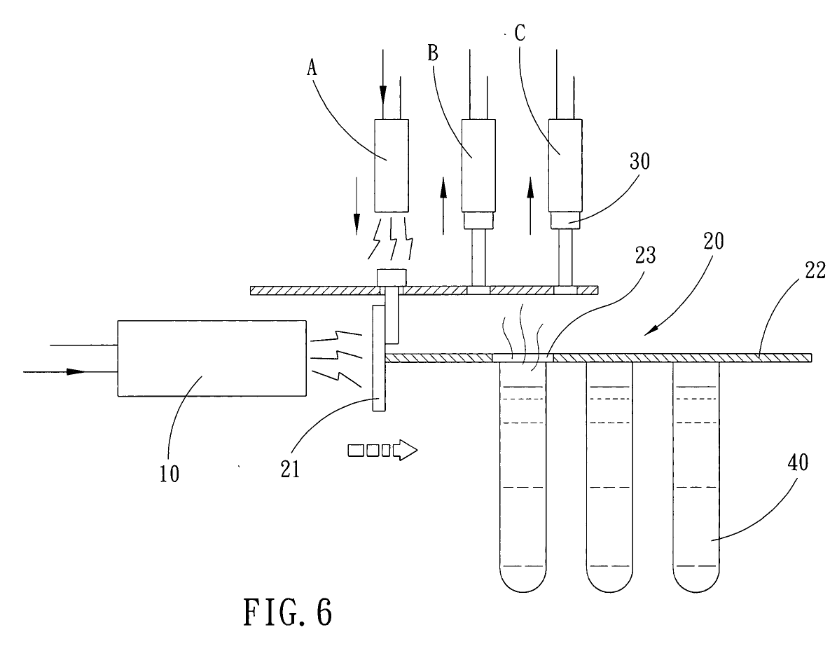

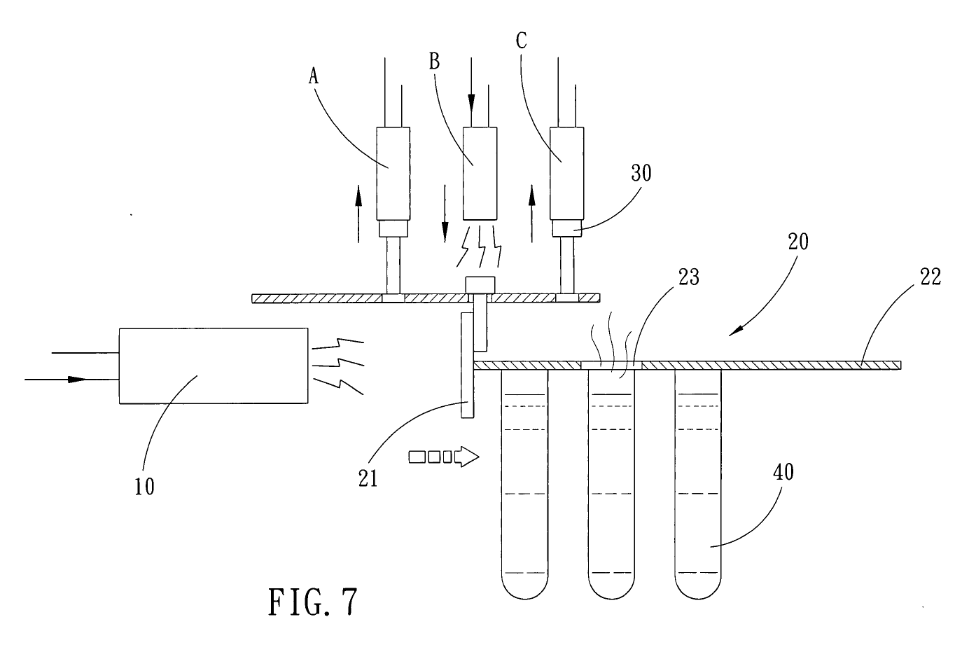

Referring to FIGS. 5-7, a fragrance emitting and stopping device for a cell phone in accordance with a second embodiment of the present invention is similar to that of the first embodiment, except the following aspects:

There are three positioning members 30 in this embodiment (positioning members 30 are permanent magnetic iron for example) and they are located opposite a first electromagnetic iron A, a second electromagnetic iron B and a third electromagnetic iron C that are arranged at certain intervals. For example, the cell phone can differentiate three different signals and output current the first, second and third electromagnetic irons A, B and C, respectively, causing repulsion of the three electromagnetic irons A, B and C relative to the positioning members 30. furthermore, there are three fragrance bottles 40, the three electromagnetic irons A, B and C are movable relative to the fragrance bottles 40, and the through hole 23 on the slide base 22 of the slide device 20 is also movable relative to the fragrance bottles 40.

When a call comes in, the cell phone will produce a detection signal and send current to the activator 10, and the activator 10 will produce an electromagnetic force. Since the permanent magnetic iron 21 of the slide device 20 is located opposite the activator 10, the magnetic force generated by the activator 10 will repel the magnetic force of the magnetic iron 21, and as a result, the slide device 20 will be caused to move and the through hole 32 will move along with the slide device 20. At this moment, when the cell phone produces a detection signal and sends current to one of the three electromagnetic irons A, B and C, causing repulsion of the three electromagnetic irons A, B and C relative to the positioning members 30. The positioning members 30 will stop the slide device 20 to a position at which the through hole 23 on the slide base 22 of the slide device 20 is aligned to one of the mouth of the fragrance bottles 40. Therefore, the fragrance can be released from one of the fragrance bottles 40 through the through hole 23 and the fragrance-releasing hole 50 (in this embodiment, the three fragrance bottles 40 is received with different fragrance, therefore, the cell phone can release different fragrances according to predetermined setting).

When there is no coming call, the cell phone doesn't produce detection signal, and the activator 10 will not produce any electromagnetic force. Since the permanent magnetic iron 21 of the slide device 20 is located opposite the activator 10, they will be attracted to each other, and the three electromagnetic irons A, B and C will also be attracted to the positioning members 30. Consequently the through hole 23 of the slide base 22 of the slide device 20 will move back to its original position that is offset from the fragrance bottle 40, and at this position, the cell phone stops releasing fragrance from the fragrance bottle 40.

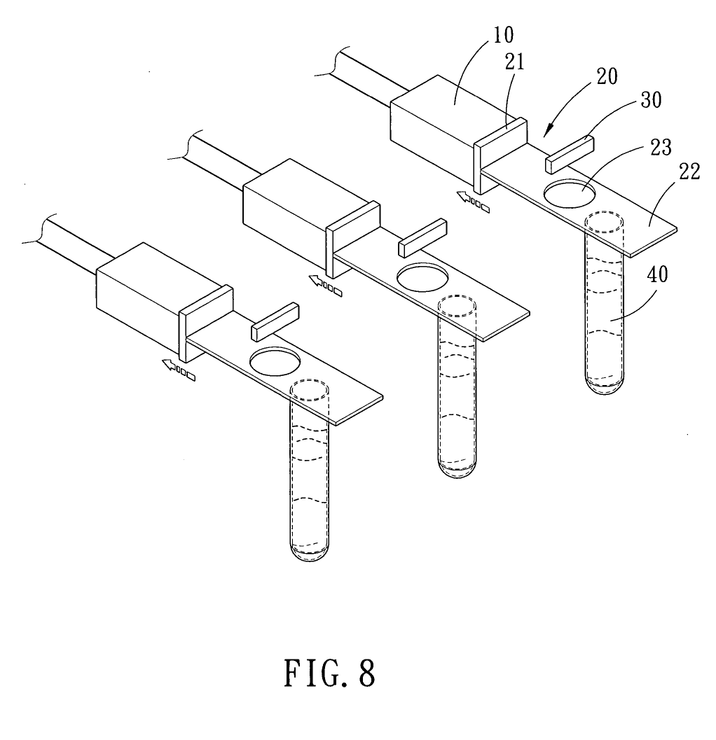

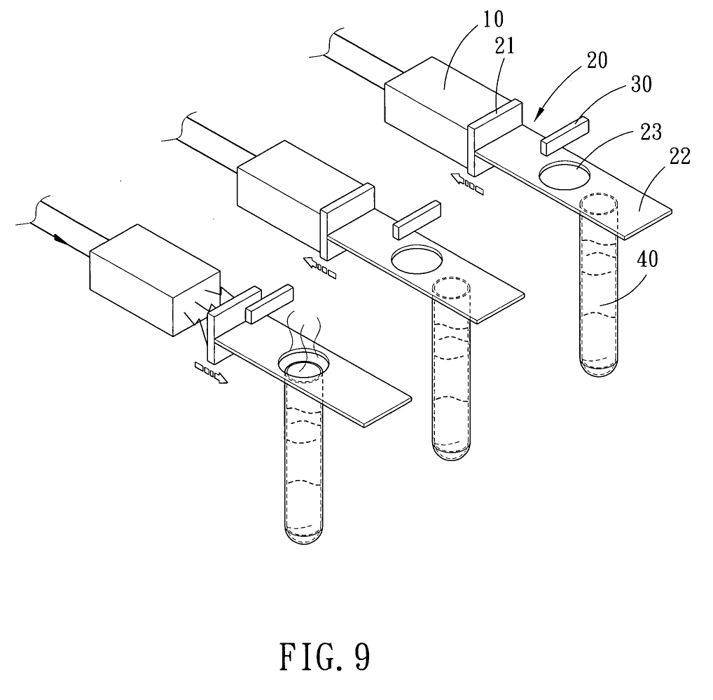

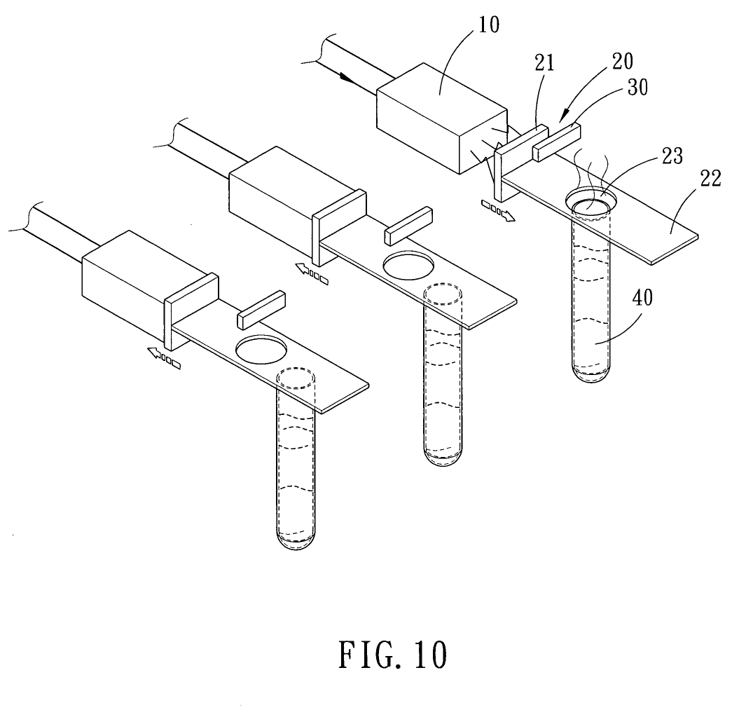

Referring to FIGS. 8-10, a fragrance emitting and stopping device for a cell phone in accordance with a third embodiment of the present invention is similar to that of the first embodiment, except the following aspects:

There are three fragrance emitting and stopping devices in this embodiment, and the fragrance bottles 40 are packed with different fragrances. When a call comes in, and according to predetermined setting, cell phone can differentiate three different detection signals and output current to the three fragrance emitting and stopping devices, respectively. The three activators 10 will be turned on and produce electromagnetic force, making the through hole 23 on the slide base 22 of the slide device 20 align with the mouth of the fragrance bottle 40. Therefore, the cell phone can release different fragrances as needed.

If there is no coming call, the cell phone doesn't produce detection signal, the cell phone will stop releasing fragrance from the fragrance bottle 40.

While we have shown and described various embodiments in accordance with the present invention, it should be clear to those skilled in the art that further embodiments may be made without departing from the scope of the present invention.

What is claimed is:

1. A fragrance emitting and stopping device for a cell phone comprising an activator, a slide device and a fragrance bottle; wherein
the activator is controlled by detection signal of the cell phone, when a call comes in, the activator will produce an electromagnetic force, and if there is no coming call, the cell phone doesn't produce electromagnetic force;
the slide device comprises a permanent magnetic iron disposed on a slide base of the slide device, the permanent magnetic iron is located opposite the activator, the slide base and the permanent magnetic iron are located at both sides of the slide device, on the slide base is formed a through hole that will be caused to move when the slide base is moved by electromagnetic effect caused between the permanent magnetic iron of the slide device and the activator; and
the fragrance bottle contains fragrance substance and is located at a side of the slide device, and the through hole is allow to move to a position aligned with and a position offset from the fragrance bottle, so as to control release of the fragrance.

2. The fragrance emitting and stopping device for a cell phone as claimed in claim 1, wherein a fragrance releasing hole is formed on the cell phone.

3. The fragrance emitting and stopping device for a cell phone as claimed in claim 1, wherein the fragrance substance in the fragrance bottle is solid.

4. The fragrance emitting and stopping device for a cell phone as claimed in claim 3, wherein a mouth of the fragrance bottle is sized correspondingly to the fragrance releasing hole.

5. The fragrance emitting and stopping device for a cell phone as claimed in claim 1, wherein the electromagnetic force produced by the starter attracts the slide device.

6. The fragrance emitting and stopping device for a cell phone as claimed in claim 1, wherein the electromagnetic force produced by the starter repels the slide device.

7. The fragrance emitting and stopping device for a cell phone as claimed in claim 1, wherein a positioning member is located opposite the activator and arranged on the same side of the slide base of the slide device and serves to stop further movement of the slide device.

8. The fragrance emitting and stopping device for a cell phone as claimed in claim 7, wherein a plurality of electromagnetic irons are disposed opposite the positioning member.

9. The fragrance emitting and stopping device for a cell phone as claimed in claim 1 comprises a plurality of activators.
